(19) United States
(12) Patent Application Publication
(10) Pub. No.: US 2010/0197214 A1
(43) Pub. Date: Aug. 5, 2010

(54) ADJUSTABLE AIR VENT FOR SLIDING DOOR FRAMES

(76) Inventors: Michael F. Geremia, SR., Menifee, CA (US); Benjamin G. Merrick, Galisteo, NM (US); Chris Kraeutle, Loomis, CA (US); Brad David Malli, Bethendorf, IA (US); Jason Xavier Collins, Cedar Rapids, IA (US); Arne Lang-Ree, Los Gatos, CA (US)

Correspondence Address: Trevor Q. Coddington, Esq.;San Diego IP Law Group LLP, 12526 High Bluff Drive, Suite 300, San Diego, CA, 92130, US

(21) Appl. No.: 12/365,506

(22) Filed: Feb. 4, 2009

(51) Int. Cl. E06B 7/02; F24F 7/007

(52) U.S. Cl. 454/195; 454/251

(57) ABSTRACT

The present invention provides a cooling system, which is referred to herein as a slider vent, for dwellings or residences that have a sliding patio door or the like. In an embodiment of the invention, the slider vent occupies approximately six (6) inches of the sliding door track and uses two centrifugal fans to exhaust hot interior air within the dwelling directly to the exterior of the residence and draws in cooler exterior air from outside the dwelling via an adjacent open window. The electrical components within the unit are enclosed by an inner housing for consumer safety and to protect them from the elements, and ventilation flows through an assemblage of moveable shutters that remain closed when the fans are not in operation. The unit is powered by a household power source via a plug connected at the bottom of the unit on the interior side. The unit also has a variable speed control to adjust air flow, located in the center of the unit, also on the interior side. For security purposes, the slider vent locks into the door frame in the same fashion as the sliding patio door, and also allows the sliding door to lock into the unit's frame to create a solid barrier to prevent unwanted entry or intrusion. The unit may also include a weather strip that produces a tight seal between itself and the sliding door and prevents the outside elements from penetrating through the crack. The unit may also include insulation to produce a tight seal when the fans are not in use to prevent the loss of air through the system while not in operation.

### BACKGROUND OF THE INVENTION

1. Field of Invention

This invention relates to air fan and ventilation systems and, more specifically, to a height adjustable air vent for installation into varying size sliding door frames.

2. Description of Related Art

In warmer climates where the outside day temperature can be relatively high and sunlight is abundant, the interior air of dwellings and living spaces often becomes hot and uncomfortable to the average person during the day. This uncomfortable interior heat typically lasts well into evenings and night time after the outside air cools down and the sun sets. Typically, habitants of dwellings spend more time in the dwelling during evenings and nights than they do during the day due to commitments arising from work, school, etc. Thus, during the evenings and nights it is desirable to cool the interior air down to a level comfortable to the habitant(s) of the dwelling.

Air conditioners, whether centrally installed in the dwelling or within a window of the dwelling (i.e., a window unit), are often used to cool the interior air and usually provide an effective means for such. However, conventional air conditioners require substantial amounts of costly electricity to operate (and are considered by many to not be energy-efficient) and often use toxic and/or expensive refrigerants that can cause damage to the environment.

Non-refrigerant systems such as fans are often used in place of air conditioners. However, fans if placed within the interior of a dwelling typically only move the existing hot air around and typically do not provide a desirable level of comfort to the habitant(s) of the dwelling. A whole house fan is a large exhaust fan used to exhaust the entire interior air volume of a house to the exterior in a short period of time (i.e., several air changes per hour). Yet, whole house fans require substantial operating space, e.g., an attic, and permanent installation within the dwelling. Many smaller dwellings such as apartments, condominiums, and mobile homes lack such space and therefore are not able to accommodate whole house fans.

Accordingly, there is a need for an alternative cooling approach to cool dwellings where whole house fans and air conditioners are not practical and/or desirable, or unable to be installed, or to supplement the use of an air conditioner.

### SUMMARY OF THE INVENTION

The present invention overcomes these and other deficiencies of the prior art by providing a cooling system, which is referred to herein as a slider vent, for dwellings or residences that have a sliding patio door or the like. The slider vent exhausts warm air from the interior of a residence directly to the exterior of the residence, while simultaneously pulling cooler outside air into the residence from an open window or door in another part of the residence. The slider vent is capable of cycling the air in a residence numerous times per hour. The slider vent expands to the height of a sliding patio door, and installs directly into the door track without altering any portion of the residence in a permanent fashion.

In an embodiment of the invention, the slider vent occupies approximately six (6) inches of the sliding door track and uses two centrifugal fans for maximum ventilation and minimum spatial burden. The electrical components within the unit are enclosed by an inner housing for consumer safety and to protect them from the elements, and ventilation flows through an assemblage of moveable shutters that remain closed when the fans are not in operation. The unit is powered by a household power source via a plug connected at the bottom of the unit on the interior side. The unit also has a variable speed control to adjust air flow, located in the center of the unit, also on the interior side. For security purposes, the slider vent locks into the door frame in the same fashion as the sliding patio door, and also allows the sliding door to lock into the unit's frame to create a solid barrier to prevent unwanted entry or intrusion. The unit may also include a weather strip that produces a tight seal between itself and the sliding door and prevents the outside elements from penetrating through the crack.

In an embodiment of the invention, a device for moving air through a door frame having a sliding door and a door lock to secure the sliding door to the door frame when closed comprises: a support frame, a fan array partially enclosed by the support frame, a height adjuster affixed to the support frame, and a latch affixed to the support frame, wherein the latch is configured to secure the device to the door lock. The fan array can comprise two fans. The latch is disposed between the two fans. Each of the two fans is driven by a separate motor. The height adjuster comprises a spring and a toggle clamp and a telescoping extension and ratchet system. The sliding door may be moved relative to the device when the device is secured to the door frame. An exterior plate can be affixed to the support frame, wherein the exterior plate comprises at least one vent. The vent comprises adjustable shutters that close when the fan array is not in operation.

The slider vent is a low-cost and energy efficient alternative to purchasing and/or paying the usage costs of a central air conditioning system. The slider vent can be installed in and will be most beneficial to an apartment, condo style, or mobile home dwelling that does not have the attic space that is required to install and use a whole house fan. Yet, the slider vent can also be installed in any residence with a sliding patio door including single family homes, where it can provide the same benefits as when installed in an apartment/condo as it does not make any permanent modification to the residence and is easy to install and use.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 illustrates a sliding door venting system according to an embodiment of the invention;

FIG. 2 illustrates an exploded view of the slider vent according to an embodiment of the invention;

FIG. 3 illustrates a lower, or “fine adjustment” height adjustor of the slider vent shown in FIG. 2;

FIG. 4 illustrates an upper, or “gross adjustment” height adjuster according to an embodiment of the invention;

FIG. 5 illustrates a lock mechanism of the slider vent shown in FIG. 2; and

FIG. 6 illustrates a slider vent with an alternative fan configuration according to another embodiment of the invention.

### DETAILED DESCRIPTION OF EMBODIMENTS

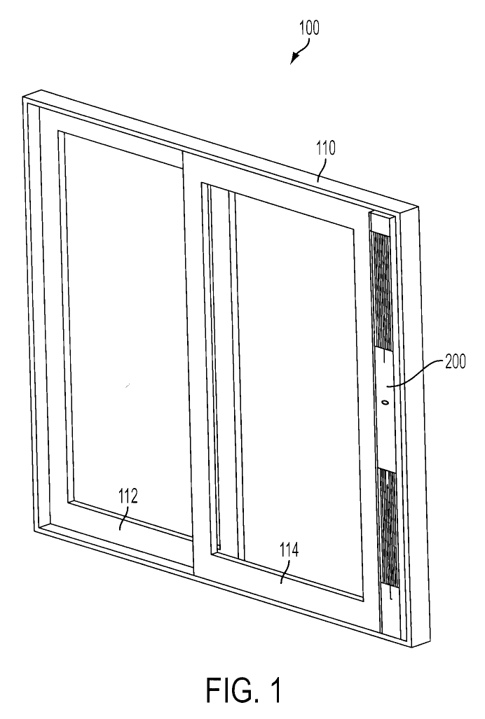

Embodiments of the present invention and their advantages may be understood by referring to FIGS. 1-6, wherein like reference numerals refer to like elements. Although the following embodiments are described in the context of installing the invention in a sliding door frame, it is readily appreciated by one of ordinary skill in the art that the invention can be adapted to other exterior openings of a dwelling such as, but not limited to windows, other types of doors, and exhaust ports. One of ordinary skill in the art also appreciates that the present invention can be adapted for permanent installation in the exterior wall of a residence. For example, the sliding vent can be installed during construction of a building as part or an extension of any type of door frame, or could be placed anywhere along the exterior wall.

The slider vent concept described herein is particularly well suited for smaller dwellings such as, but not limited to apartments, condominiums, and mobile homes, and is designed to be preferably installed in sliding patio door frames in a user-friendly way that does not require any permanent modification to the dwelling though it securely locks into place once installed. The slider vent provides optimal cooling in climates where evenings are substantially cooler than daytimes. For example, during the evening, the user opens a window (ideally on the opposite side of the dwelling) and then turns on the fan, which exhausts the hot air from inside the dwelling and draws cooler outdoor air in through the open window (or vice-versa), thereby creating a much more time and energy-efficient way to cool small dwellings. It is also apparent that a steady flow of moving air throughout a residence provides habitants substantial cooling and makes the residence more comfortable even when outside air temperature is the same as the interior temperature. This is also true in humid climates where moving air, or the “breeze” effect, is more comfortable than stale non-moving air.

FIG. 1 illustrates a sliding door venting system 100 according to an embodiment of the invention. The sliding door venting system 100 comprises a sliding door frame 110 and a slider vent 200. The sliding door frame 110 can be any commercially available or custom sliding patio doorframe that comprises a fixed door 112 (i.e., fixed in position) and a sliding door 114. With the sliding door 114 positioned in an open position, thus creating an opening between the interior and exterior of the dwelling, the slider vent 200 is installed in a small portion of that opening, which is created by the sliding door 114 and the sliding door frame 110. The slider vent 200 further includes a control panel (not shown in FIG. 1), which preferably includes at least a power switch and fan speed adjuster, and a power cord (not shown, but can emanate from the unit near the floor) for providing electrical power from a conventional power source, e.g., an electrical outlet within the dwelling. In an embodiment of the invention, the slider vent 200 is rectangular shaped, where its height is substantially greater than its width as shown in order to minimize the horizontal space occupied in the door frame 110 while still permitting the sliding door 114 to be opened and closed.

In operation, the slider vent 200 moves air through the sliding door frame 110 from one side, e.g., the interior or inside of an apartment, to the other side, e.g., the exterior of the apartment (or vice versa). For example, during the evenings when outdoor air is cooler than indoor air, the user turns on the slider vent 200 and opens an adjacent window (not shown) of the apartment. The slider vent 200 draws in cooler outdoor air through the open window and exhausts the warmer indoor air outside through its vents, thereby cooling the interior of the apartment in a timely and energy efficient manner.

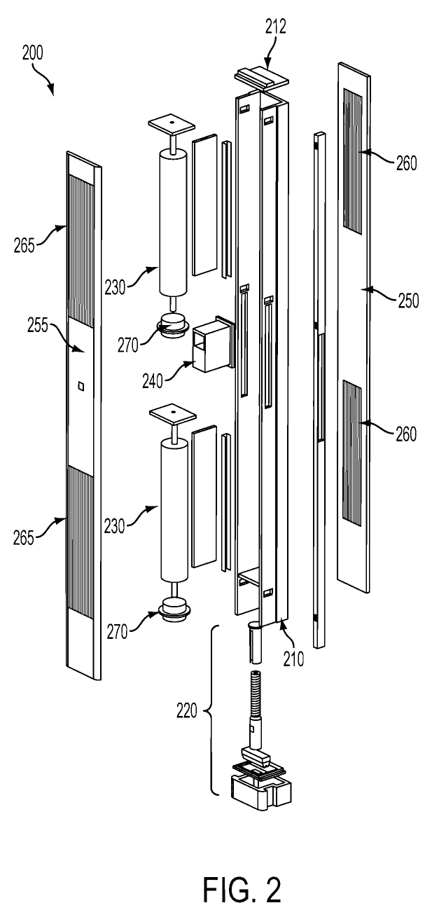

FIG. 2 illustrates an exploded view of the slider vent 200 according to an embodiment of the invention. Particularly, the slider vent 200 comprises a support frame 210, a height adjuster 220, a fan array 230, a lock mechanism 240, and case plates 250 and 255. The heaviest components of the slider vent 200 are ideally situated at the bottom of the unit to lower the unit's overall center of gravity in order prevent the unit from falling over during installation. In an exemplary embodiment, the slider vent 200 measures 6 inches wide by 5 inches deep by 77 inches tall (although overall height is adjustable as noted below) to fit entirely within a small opening of the door frame 110.

The support frame 210 is preferably manufactured from a lightweight rigid material such as, but not limited to aluminum. In an embodiment of the invention, the support frame 210 is manufactured into its shape by stamping and/or folding aluminum sheet, the implementation of which is apparent to one of ordinary skill in the art. Finite elemental analysis (FEA) of the illustrated shape has revealed the support frame 210 to be exceedingly sturdy and able to withstand very heavy loading, i.e., the support frame 210 easily withstood preliminary tests with 200 lb. compression and tension loading (e.g., slamming or pulling of the sliding door 114 against or away, respectively from the slider vent 200). The support frame 210 provides a physical barrier to the internal components, e.g., fan blades, motors, and electrical systems. In an embodiment of the invention, the support frame 210 is manufactured in such a way to mimic the indentation of the widest existing door frame, and all slots and screw holes used for mounting other components of the slider vent 200 are cut into the support frame 210.

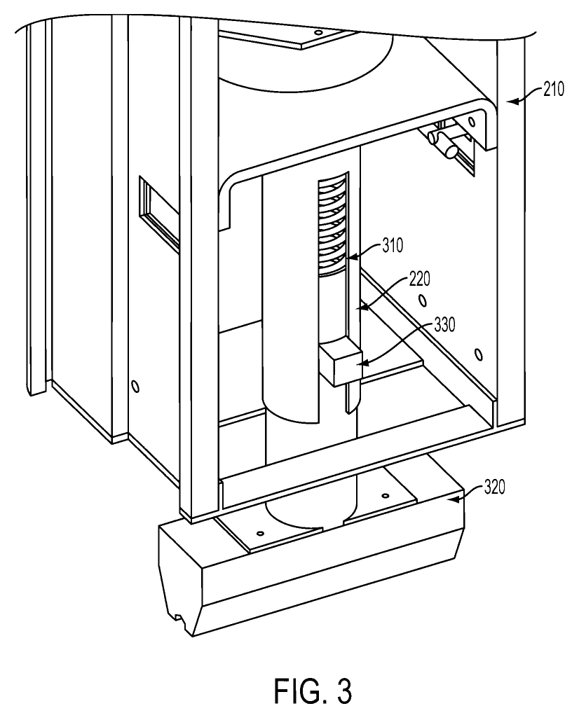

The height adjuster 220 is provided to accommodate different size door frames 110 available commercially. For example, conventional door frames typically vary in height from 79 to 83 inches for apartments and condo dwellings, although the present invention is not intended to be so limited as any door height can be accommodated. As shown in FIG. 3, in order to accommodate different door frame heights, the height adjustor 220 comprises a spring mounted mechanism 310 that adjusts the overall height of the slider vent 200 and provides resistance to movement of the slider vent 200 relative to the upper and lower support members of the door frame 110.

The spring mounted mechanism 310 also facilitates a relative easy user installation process. First, the user places the slider vent 200 in an opening of the sliding door frame 110 such that a top plate 212 of the slider vent 200 is in contact with the top corner of the door frame 110. The top plate 212 is shaped to snugly fit within the door track of the door frame 110. The user then compresses the spring 310 and moves the bottom of the slider vent 200 into position at the bottom corner of the door frame 110. In an embodiment of the invention, the height adjuster 220 comprises an extension block 320 for taller door frames 110, i.e., those exceeding 80 inches. The slider vent 200 is then secured to the door frame 110 via the locking mechanism 240 as described below.

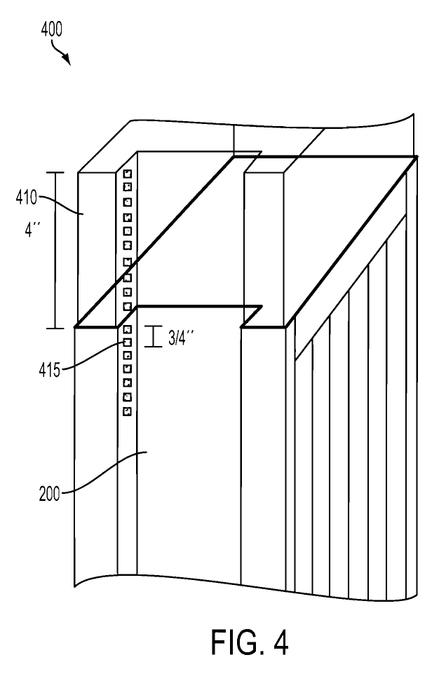

FIG. 4 illustrates an optional gross height adjustment mechanism 400 according to an embodiment of the invention. Particularly, the gross height adjustment mechanism 400 comprises a telescoping upper portion 410 in addition to the spring mechanism 220 (as shown in FIG. 3). The slider vent 200 is installed in a simple two-step process according to an embodiment of the invention. After positioning the slider vent 200 upright in the door frame 110 and butted up against the side of the door frame 110, the user extends the telescoping upper portion 410 of the slider vent 200 until it makes contact with the header of the door frame 110. A ratchet mechanism 415 in the telescoping portion 410 maintains the uppermost position of this portion to the closest discrete ratchet position. The ratchet 415 extends in intervals on the order of ⅛ inches to ¼ inches to provide “gross adjustment” according to an exemplary embodiment of the invention. The final height adjustment and the vertical loading required to rigidly fix the slider vent 200 in position is provided by the spring mounted mechanism 220. An over-center toggle clamp 330 is used to first extend the compliant foot pad 320, which takes up the remaining overall height difference, and second to compress the spring 310, loading the spring to the desired vertical installation force.

In an embodiment of the invention, the fan array 230 comprises two centrifugal fan blades (otherwise known as tangential blowers) arranged vertically and driven by two respective electrical motors 270. This exemplary fan configuration was chosen in at least one embodiment of the invention in order to provide space for the lock mechanism 240, which typically needs to be located in the middle (relative to height) of the slider vent 200 in order to accommodate standard sliding door locks. For example, variability in conventional door lock positions necessitated a separation of 20 inches between the fans in the fan array 230, leading to the inclusion of two motors 270.

In a particular exemplary embodiment of the invention, each blade measures 4 inches in diameter and 20.9 inches tall. Each fan blade can be driven by its own motor 270 such as a 40 Watt motor. Preferably, the fan array 230 is optimized such that it occupies minimal space while providing maximum air flow with minimal noise, e.g., less than 52 dB. Experimental results of such an exemplary configuration have shown that the slider vent 200 moves at least 1000 CFM (cubic-feet per minute) of air, which is enough to refresh the entire volume of air inside an 800 square foot living space once about every 6.5 minutes.

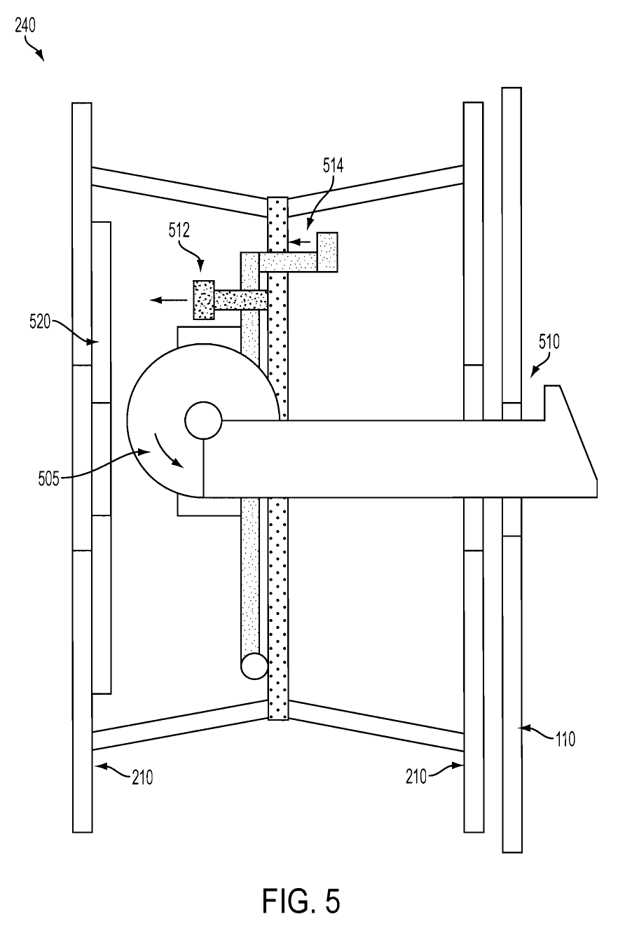

The lock mechanism 240 preferably adapts to the different types of locks found in various sliding door frames 110 and provides intruder security as good or better then that provided by the existing installed door frame 110. As shown in FIG. 5 according to an exemplary embodiment of the invention, the lock mechanism 240 comprises a latch arm 510, which engages door frame 110 in the same manner as the lock on the sliding door 114. As the slider vent 200 is positioned in the doorframe 110 as discussed above, the latch arm 510 engages a rectangular hole in the strike plate on the frame 110, hooking behind the edge of the hole in the sheet metal by rotating upward. A torsion spring 505 biases the latch arm 510 upward to engage door frame 110. The spring-loaded upward rotation of the latch arm 510 will inherently adjust to minor variations in hole height. Adjustability in the vertical position of the latch arm 510 as a whole accommodates larger variations.

The slider vent 200 is drawn in towards the doorframe 110 by tensioning the latch arm 510 with a screw 512 pulling back on the latch finger 510. The tension applied is determined by a limiter 514 to prevent the user from overtightening and damaging the doorframe 110. A lock plate 520 is provided to mimic the door frame 110 providing a slot for door lock of sliding door 114. In an embodiment of the invention, the entire locking mechanism 240 is easily detached from and reinserted into the slider vent 200 to allow both right-closing and left-closing door installation. A second optional mechanism (not shown) can be included with the slider vent 200 which emulates the outrigger style of lock, characterized by a bent sheet metal hook which engages a lip in the door frame external to the frame of the sliding glass door.

Case plates 250 and 255 are manufactured from a suitable material such as aluminum or plastic in an embodiment of the invention. Other materials may be added to the case plates 250 to improve the visual and tactile compliment to any door frame. For example, bamboo plates or another type of aesthetically pleasing wood, metal, or plastic may be added to the exterior of the support frame to improve both the visual appearance of the slider vent 200 and to help protect the slider vent 200 from the outdoor elements. In an embodiment of the invention, the exterior case plate 250 and interior case plate 255 each include two vents 260 and 265, respectively. Vents 260 can be made adjustable to direct air flow and are designed to resist rainfall from entering the unit, preferably up to a 20 degree rain. Vents 265 are also adjustable to direct air flow and to keep small insects and pests from entering the residence while the fans are not in operation. For example, vents 265 can be opened via a mechanical lever (not shown) or simply by air forced out by the fan array 230. An optional weather strip (not shown) can be included to seal the slider vent 200 from the outside and to prevent pests from entering the dwelling. The sliding door 114 is closed and locked to the locking mechanism 240. Nonetheless, the sliding door 114 can also be unlocked and opened for normal exit and entry while the slider vent 200 is installed in the door frame 110 as the tension system 220, 410 and locking mechanism 240 continue to hold the slider vent 200 securely in place. During winter months, the slider vent 200 can be removed. The shutter system can also contain insulation to create a tight seal to prevent the loss of air through the system when the slider vent 200 is not in operation.

In an alternative embodiment of the invention, the slider vent 200 is designed to move air from the exterior of the dwelling in one part and exhaust interior air of the dwelling from another part. For example, fan assembly 230 is configured to exhaust hot interior air through upper vent 260 while moving cooler outside air through lower vent 260. This type of configuration is particularly useful for studio apartments and the like that do not have any windows.

One of ordinary skill in the art readily appreciates that many different fan configurations can be implemented in the slider vent 200. For example, a single fan with a single motor can be implemented rather than two fans. Alternatively, as described below, three or more fans may be implemented.

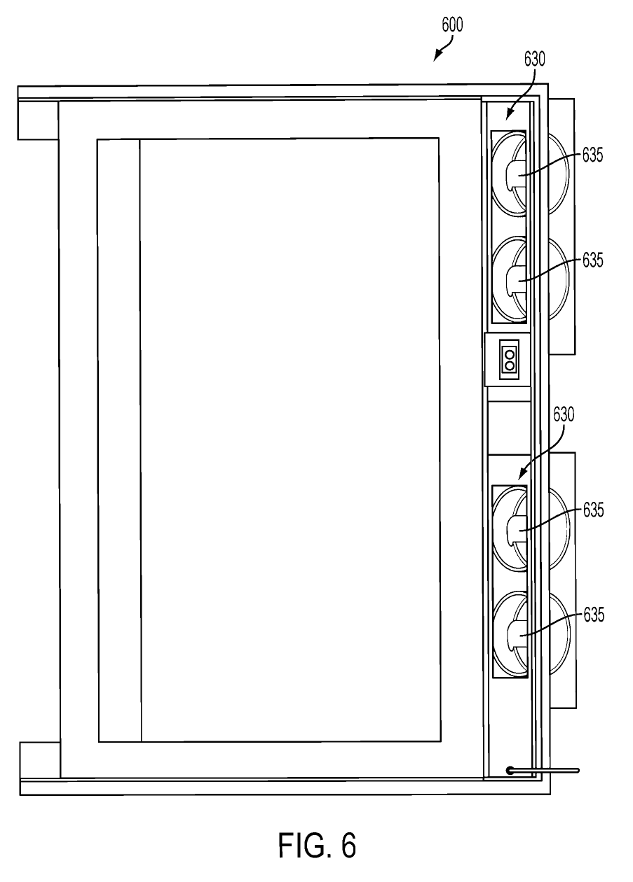

FIG. 6 illustrates a slider vent 600 with an alternative fan configuration according to another embodiment of the invention. Here, slider vent 600 comprises a fan assembly 630, which includes four fans 635, two of which are disposed on the upper portion of the slider vent 600 and two of which are disposed on the lower portion. As shown, fans 635 extend outward on the exterior side of slider vent 630 and are disposed at an angle away from the sliding door 114.

In an alternative embodiment of the invention, the slider vent 200 can be powered by exterior solar panels, the identification and implementation of which are apparent to one of ordinary skill in the art, rather than an electrical outlet of the dwelling. This enables the slider vent 200 to be operated from stored solar energy until depleted, upon which the slider vent 200 would switch to an electrical outlet for power. The solar panel can be installed on the roof of the dwelling or building, or be disposed directly on the slider vent 200 itself. An optional electricity meter could be included to display how much energy the unit is using to operate.

In yet another alternative embodiment of the invention, the slider vent 200 can include an optional smoke detector sensor (not shown), to automatically shut off the unit in the case of a fire or alternatively turn on the unit in case it was desirable to exhaust smoke in the air from the dwelling, perhaps from a kitchen.

The slider vent 200 may also include an optional timer or automated controller (not shown) to control variable speed operation and to allow operation for specified length of time and/or on specified time periods, i.e., days and hours, of the week. Alternatively, the slider vent 200 may include an optional thermostat and indicator system (not shown) to notify the habitant when the slider vent 200 should be operated, i.e., within desirable temperature ranges based on indoor and outdoor temperatures.

An optional air filter (not shown) may be included within the slider vent 200 as well. For example, the slider vent 200 may include a HEPA filter to remove undesirable particulates in the air, particularly if slider vent 200 is used to bring in exterior air into the interior of the dwelling. Alternatively, a HEPA filter can be placed in the adjacent open window or door screen that is used during the operation of the slider vent 200 to cycle in clean filtered air through the dwelling.

In another embodiment of the invention, the slider vent 200 is installed into a sliding window rather than a sliding door. The slider vent 200 shall fit in the track of the window and include a locking mechanism for locking the unit into the window frame and allow the window to be locked to the unit.

In yet another embodiment of the invention, the slider vent 200 comprises various gas sensors to trigger operation. For example, the slider vent 200 can include one or more gas sensors for carbon monoxide, radon, propane, natural gas, etc., which would turn on the unit when those respective gases are detected, thereby exhausting those gases and protecting the health of the dwelling habitants.

In another embodiment of the invention, the slider vent 200 can be adapted to be built directly into the exterior frame of an apartment, condominium, mobile home, or a single family residence. The slider vent 200 can be installed directly adjacent or within the sliding door frame 110, and therefore would appear to just be an extension of the door allowing the builder to extend the door frame 110 width to make it fit, or it could be installed anywhere along the exterior wall of the residence between studs. This adaptation would make the slider vent 200 a permanent fixture to the residence, and would include a hatch system to enable someone to be able to open the unit to replace parts or the whole system over time. The built-in slider vent would also be hard wired to the residence through wiring within the walls. This adaptation will also allow for the size of the unit to be contorted in any manner (or manufactured in any size or dimension) necessary as it will no longer be constrained to fit within a sliding door frame, i.e., it could be extended all the way to the ceiling or to a greater width and depth to allow for larger fans and to create a greater air flow potential. The built-in unit would also include a weatherization plate/panel with insulation that would be attached to the unit during the winter/cold months to seal the unit and residence to keep the cold air out of the residence and warm air inside the residence when the sliding vent 200 is not operated. Alternatively, the built in unit could also contain a permanent amount of insulation to prevent the loss of both cool conditioned air during the summer as well as warm air in the winter when the unit is not in operation.

In another embodiment of the invention, the slider vent 200 comprises an automatic shut off circuit when negative air pressure is present, i.e., no windows or doors are open in the dwelling to bring in outside air. Negative pressure can make it difficult to open doors and/or windows, which could be very dangerous when emergency exit is necessary for the habitants, and can also cause backdrafting on combustion appliances that are installed within the conditioned space such as gas stoves and water heaters.

In another embodiment of the invention, the slider vent 200 can be adapted to be built directly into a standard hinged door that leads to the exterior of a residence. The door would be modified or built to fit the slider vent 200 into the door itself and would not inhibit opening or closing the door or from closing and locking into the door frame. This adaptation would allow the vent to easily be installed in existing homes of all types, including those that do not have sliding patio doors.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A device for moving air through a door frame, the door frame comprises a sliding door, the device comprising:
a support frame,
a fan array partially enclosed by said support frame,
a height adjuster affixed to said support frame, and
a latch affixed to said support frame, wherein said latch is configured to secure said device to said door frame.

2. The device of claim 1, wherein said fan array comprises two fans, one of which is disposed at an upper portion of said device and the other of which is disposed at a lower portion of said device.

3. The device of claim 2, wherein said latch affixed to said support frame is disposed between said two fans.

4. The device of claim 2, wherein each of said two fans is driven by a separate motor.

5. The device of claim 1, wherein the height adjuster comprises a spring and a toggle clamp.

6. The device of claim 1, wherein the height adjuster comprises a telescoping extension.

7. The device of claim 1, wherein said sliding door may be moved relative to said device when said device is secured to said door frame.

8. The device of claim 1, further comprising an exterior plate affixed to said support frame, wherein said exterior plate comprises at least one vent.

9. The device of claim 7, wherein said at least one vent comprises adjustable shutters that close when said fan array is not in operation.

10. The device of claim 9, wherein said adjustable shutters comprise insulation to prevent the loss of air through said device when said fan array is not in operation.

11. The device of claim 1, wherein said fan array comprises at least one tangential blower.

12. The device of claim 1, further comprising a lock plate for securing said sliding door to said device.

13. An air exhaust vent comprising:
a fan,
a height adjuster to adjust an overall height of said air exhaust vent, and
a reversible latch to secure said air exhaust vent to a door or window frame.

14. The vent of claim 13, wherein said fan comprises two tangential blowers.

15. The vent of claim 14, wherein said reversible latch is disposed between said two tangential blowers.

16. The vent of claim 13, wherein said height adjuster comprises a telescoping portion and a spring loaded toggle switch.

17. The vent of claim 13, wherein said reversible latch comprises a lock plate to receive and secure a latch of a sliding door.

18. The vent of claim 13, wherein said vent is rectangular shaped having a height greater than its width.

19. A vent for exhausting air directly to the exterior of a residence, as opposed to an attic, the vent comprising:
a fan array, and
adjustable shutters comprising insulation to prevent the loss of air through the system while said fan array is not in operation,
wherein said vent is configured to be built into an exterior wall of a building.

20. A vent for exhausting air directly to the exterior of a residence, as opposed to an attic, the vent comprising:
a fan array, and
adjustable shutters comprising insulation to prevent the loss of air through the system while said fan array is not in operation,
wherein said vent is configured to be built directly into a hinged door.
